(19) United States
(12) Patent Application Publication
(10) Pub. No.: US 2008/0043726 A1
(43) Pub. Date: Feb. 21, 2008

(54) Selective Control of User Equipment Capabilities

(75) Inventors: Christian Herrero-Veron, Lund (SE); Svante Alnas, Lund (SE); Krister Sallberg, Lund (SE)

Correspondence Address: POTOMAC PATENT GROUP PLLC, P. O. BOX 270, FREDERICKSBURG, VA, 22404, US

(73) Assignee: Telefonaktiebolaget L M Ericsson (publ), Stockholm (SE)

(21) Appl. No.: 11/745,165

(22) Filed: May 7, 2007

Related U.S. Application Data
(60) Provisional application No. 60/823,011, filed on Aug. 21, 2006.
(60) Provisional application No. 60/823,014, filed on Aug. 21, 2006.
(60) Provisional application No. 60/862,080, filed on Oct. 19, 2006.
(60) Provisional application No. 60/862,472, filed on Oct. 23, 2006.
(60) Provisional application No. 60/886,729, filed on Jan. 26, 2007.
(60) Provisional application No. 60/886,745, filed on Jan. 26, 2007.
(60) Provisional application No. 60/886,753, filed on Jan. 26, 2007.
(60) Provisional application No. 60/896,314, filed on Mar. 22, 2007.

(51) Int. Cl. H04L 12/66; H04M 11/04; H04Q 7/20

(52) U.S. Cl. 370/352; 455/404.1; 455/466

(57) ABSTRACT

Services to user equipment in communication networks, and in particular basic operational services, are controlled through a device management object through which services are selectively disabled and enabled.

This application claims the benefit of the filing dates of U.S. Provisional Patent Applications No. 60/823,011 filed on Aug. 21, 2006; No. 60/823,014 filed on Aug. 21, 2006; No. 60/862,080 filed on Oct. 19, 2006; No. 60/862,472 filed on Oct. 23, 2006; No. 60/886,729 filed on Jan. 26, 2007; No. 60/886,745 filed on Jan. 26, 2007; No. 60/886,753 filed on Jan. 26, 2007; and No. 60/896,314 filed on Mar. 22, 2007. The content of all of those provisional applications is incorporated here by reference.

### BACKGROUND

This invention relates to electronic communication systems, and more particularly to electronic communication systems having user equipment configurable with different software components.

Today, several actors are involved in managing the software and hardware of a user equipment (UE), such as a mobile telephone or other communication device in a wireless communication system. The software can be applications, services, and modules, including the operating system (OS), stored in and used by the UE. The UE's manufacturer typically installs a collection of software in the UE at the time the device is manufactured. Later on, an end user may modify the UE's software by downloading to the UE applications, etc., from different sources via, for example, the Internet. The UE's manufacturer, the operator of the communication system to which the UE is subscribed or in which the UE is visiting, and/or an authorized third party, depending on business agreements, may also remotely modify part or all of the UE's software.

After such modifications and in other instances, the UE may behave improperly. From a system operator's point of view for example, improper behavior includes the UE's diminishing the capacity of the communication system by increasing the number of control or other messages exchanged with the system. Improper UE behavior can arise in a number of ways, e.g., unexpected interactions between software modules in the UE, malicious software modules, etc. A user might download a malicious or malformed application, for example, a Java application, that interacts with the network-protocol stack through open application programming interfaces (APIs) in the UE. As a result, the UE might repeatedly send service requests to an operator's network.

Type approval is always done of all radio signaling software. For example, type-approved software in the UE may expose a functionality like emergency call and internet-protocol (IP) multimedia subsystem service (IMS) to the Java environment and more generally the application layer. Compared to for example the normal setting up of a call, a request will be denied if there is not enough network resources to satisfy the request, which can be a problem for a functionality like emergency call that is a high-priority request. This may not be a big problem today, but more and more functionality will be exposed to the application layer and more and more UEs can download software. When allowed features are exposed to the application layer, they can be misused; for example, a UE application may try to register an IMS session 1000 times per minute. If that application is copied to other UEs, a serious problem could result for the network operator.

Techniques for dealing with improper UE behavior by disabling services to a UE have been discussed in standardization organizations such as the Third Generation Partnership Project (3GPP). The 3GPP promulgates specifications for the GSM telecommunications system and its enhancements like Enhanced Data Rates for GSM Evolution (EDGE), the universal mobile telecommunications system (UMTS), and systems employing wideband code-division multiple access (WCDMA).

For example, Section 4.5 of 3GPP Technical Specification (TS) 22.011 V7.6.0 (March 2007), Service Accessibility (Release 7) and Section 4.5 of 3GPP TS 22.011 V8.0.0 (March 2007), Service Accessibility (Release 8) relate to the control of UE capabilities. A selective UE capabilities list of services may be maintained in the UE, and if a service on the list is indicated as disabled, the UE does not request the service from the network. The services on the selective capabilities list include call control (CC) functions, supplementary services (SS), emergency calls, short message services (SMS) via circuit-switched (CS) and packet-switched (PS) links, a location service (LCS), services based on GSM's general packet radio service (GPRS), a multimedia broadcast and multicast service (MBMS), and an IMS.

3GPP TS 22.011 follows from 3GPP Technical Report (TR) 23.805 V0.3.1 (September 2005), Selective Disabling of UE Capabilities; Report on Technical Options and Conclusions (Release 7), and 3GPP TS 24.305 V0.1.0 (March 2006), Selective Disabling of 3GPP UE Capabilities (SDOUE) Management Object (MO) (Release 7). 3GPP TR 23.805 V0.3.1 and TS 24.305 V0.1.0 introduced the selective capabilities list and device management (DM) according to the Open Mobile Alliance (OMA) for disabling UE capabilities, but did not describe any of the parameters needed for an SDOUE MO or any of the rules and corresponding behavior of the UE when services or functions are disabled/enabled. OMA has developed specifications for Device Management (DM) of communication devices, and versions 1.1.2 and 1.2 of those specifications define a protocol for managing configuration, data, and settings in communication devices. OMA standards and other information are available at http://www.openmobilealliance.org.

OMA DM can be used to manage the configuration and MOs of UEs from the point of view of different DM Authorities, including setting initial configuration information in UEs, subsequently updating persistent information in UEs, retrieving management information from UEs, and processing events and alarms generated by UEs. Using OMA DM, third parties can configure UEs on behalf of end users. A third party, such as a network operator, service provider, and corporate information management department, can remotely set UE parameters and install or upgrade software through suitable MOs in the UE. An MO is generally a software object that may be written, for example, according to SyncML, which is a mark-up language specification of an XML-based representation protocol, synchronization protocol, and DM protocol, transport bindings for the protocols, and a device description framework for DM.

As depicted in FIG. 1, a DM Management Authority (MA) 102 issues a request to a DM Server 104, for example, to provision parameters in one or more UEs. The DM Server 104 sends a Server-initiated Notification to a UE 106, which establishes a DM Session with the DM Server 104, which queries the UE for current settings (which may include UE-specific extensions). The DM Server 104 sends DM commands to adjust the UE's configuration to conform to requirements established by the DM MA 102. The UE 106 and DM Server 104 end their DM Session, and the UE is able to access network data services using the configured connectivity parameters. The DM MA or the DM Server may store the connectivity parameters on a “smart card” or the like so that the UE can use them when the UE consumes the parameters.

A UE can, for example, use a Connectivity MO for application-independent settings to connect to a network. A Connectivity MO for the network would provide connectivity information that relates to the parameters and means needed to access the network infrastructure, including network bearers, protocols, Network Access Point (NAP) addresses, and proxy addresses. According to OMA specifications, a Connectivity MO enabler handles management of wireless data connectivity by specifying a set of DM object schema that may be exposed by a DM Client and targeted by a DM Server. The object schema have three parts: a top level management object that is bearer-neutral; a set of bearer-specific parameters; and a sub-tree for exposing vendor-specific parameters. Connectivity parameters bootstrapped using Client Provisioning (CP) can be subsequently addressed and managed through the DM Server, which can add new proxies and network access points using a standardized DM package. Provisioning is the process by which a client in a device is configured, and generally covers both over the air (OTA) provisioning and other provisioning, e.g., by a subscriber identity module (SIM) card.

Nevertheless, it is difficult to use OMA DM for remotely disabling and enabling services to deal with UE behavior according to 3GPP TS 22.011. Among the problems that arise is the fact that the services to be disabled/enabled operate at layers of the protocol stack that are lower than usual for a DM Session. Another problem involves the necessity for acceptable security in controlling such basic operational features of the UE. Thus, application of OMA DM to disable capabilities of a UE is not straightforward.

### SUMMARY

In accordance with aspects of this invention, there is provided a method of operating a UE in a public land mobile network (PLMN). The method includes the steps of determining that the UE improperly requests at least one service from the PLMN; informing a management entity in a home PLMN (HPLMN) of the improper request; requesting, by the HPLMN's management entity, a device management computer server in the HPLMN to disable the improperly requested service in the UE; sending, from the HPLMN's server, a message to the UE to establish a management session between the UE and the server; and accessing an SDOUE management object in the UE such that the improperly requested service is disabled

In accordance with further aspects of this invention, there is provided a UE capable of communication with a device management server. The UE includes a processor configured to execute software components existent in the UE and control UE services. The software components include an SDOUE management object that is configurable by the processor to disable UE services based on a management session established between the UE and the server.

In accordance with further aspects of this invention, there is provided a computer-readable medium having instructions that, when executed by a processor in a UE in a PLMN, cause the processor to perform the steps of: determining that the UE improperly requests at least one service from the PLMN; informing a management entity in an HPLMN of the improper request; requesting, by the HPLMN's management entity, a device management computer server in the HPLMN to disable the improperly requested service in the UE; sending, from the HPLMN's server, a message to the UE to establish a management session between the UE and the server; and accessing an SDOUE management object in the UE such that the improperly requested service is disabled.

### BRIEF DESCRIPTION OF THE DRAWINGS

The various objects, features, and advantages of this invention will be understood by reading this description in conjunction with the drawings, in which:

FIG. 1 depicts a device management arrangement;

FIG. 2 is a flow chart of a method of operating a UE and a communication network;

FIG. 3 is a flow chart of another method of operating a UE and a communication network;

FIG. 4 is a block diagram of a user equipment;

FIG. 5 illustrates a gate control in a user equipment;

FIG. 6 is a flow chart of a method of controlling PDP context activation;

FIG. 7 is a block diagram of a communication system, including a user equipment and a portion of a network; and

FIG. 8 depicts a network.

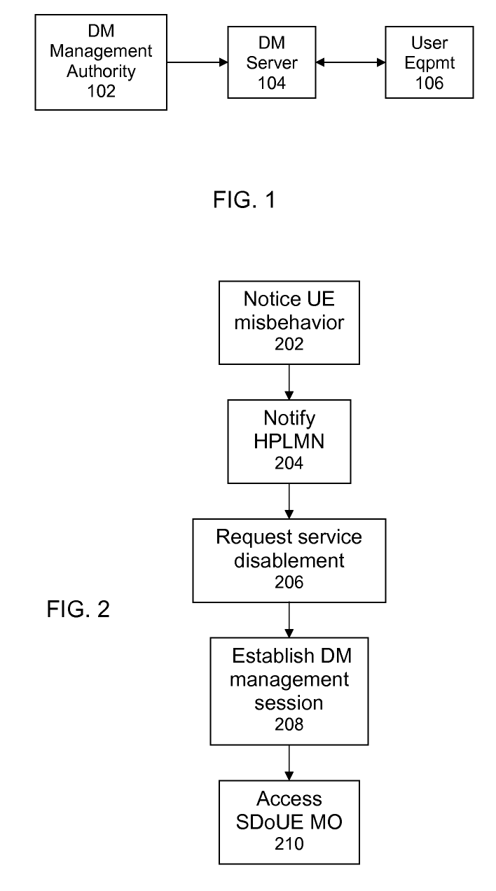

### DETAILED DESCRIPTION

This application focuses on wireless communication systems that comply with specifications promulgated by the 3GPP for economy of explanation, but it will be understood that the principles described in this application can be implemented in other communication systems. It will also be understood that this description is written in terms of OMA DM, but this description should not be interpreted as being limited to OMA DM. Independent of the mechanism used to disable or enable services in a UE, it is advantageous for the UE to be selectively controllable in a standardized way.

The inventors have recognized that OMA DM can be used for disabling and enabling a specific service or function (or set of services or functions) even though some of those services/functions are needed when OMA DM is used for enabling those services/functions again. This application describes a suitable SDOUE MO and operation of a UE using the SDOUE MO in a communication system. The artisan will understand that the SDOUE MO is generally a software module that includes parameters that can be used for selectively disabling and enabling capabilities of a UE.

It is currently believed advantageous to use the standardized OMA DM Access Control List (ACL) property mechanism to grant or deny access rights to OMA DM servers in order to modify nodes and leaf objects of the SDOUE MO. The ACL property mechanism is currently described in Enabler Release Definition OMA-ERELD-DM-V1_{—}2, which is incorporated here by reference. For security reasons, a UE's HPLMN operator can use the ACL mechanism to allow or prohibit other network operators (e.g., operators of visited PLMNs (VPLMNs)) to access the UE's SDOUE MO through a VPLMN's DM server while the UE is roaming as described below.

The following Table 1 depicts an exemplary logical tree structure, including nodes and leaf objects, of an SDOUE MO.

TABLE 1
Exemplary logical structure of an SDoUE MO

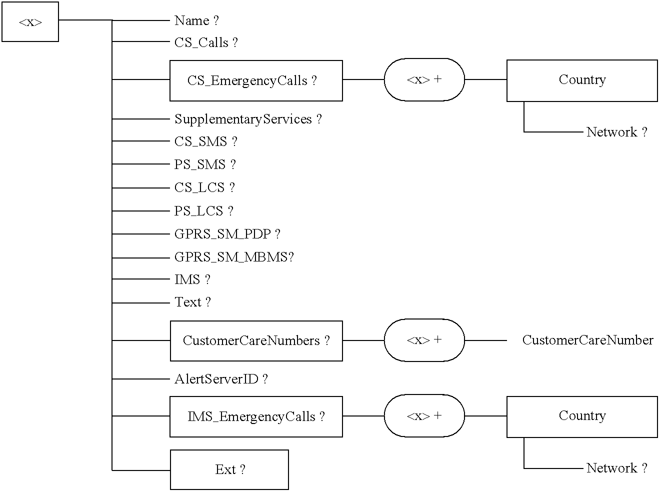

As is typical of OMA DM notation, <X> in Table 1 is a placeholder node that takes on either of two values, e.g., 0 and 1, and one or more node and leaf objects are provided under that node. The artisan will understand that, in accordance with OMA DM, the SDOUE MO has an associated MO Identifier, which enables DM servers to find the SDOUE MO in managing a particular device. The other node and leaf objects of the SDOUE MO depicted in Table 1 are as follows, and it will be appreciated that some node and leaf objects can be omitted, other node and leaf objects can be provided, and node and leaf objects can have different names, if desired:

Name, which is a leaf for SDOUE MO settings;

CS_Calls, which is a leaf that indicates a preference to enable or disable UE-originated CS call control (CC) procedures except for emergency calls;

CS_EmergencyCalls, which is an interior node that indicates an operator's preference to enable or disable CS emergency CC procedures (e.g., disabled where the CS_EmergencyCalls value is set to 1), which are specified in 3GPP TS 24.008 for example;

Country, which is a leaf that represents a country, which may be identified by a mobile country code (MCC), and enables inclusion of information that indicates in which MCC the emergency CS CC procedures are disabled (e.g., in which the CS_EmergencyCalls value is set to 1);

Network, which is a leaf that can represent a network, which may be identified by a mobile network code (MNC), and enable, with the Country leaf, inclusion of information that indicates in which MCC and MNC the emergency CS CC procedures are disabled;

SupplementaryServices, which is a leaf that enables or disables UE-originated SS operations;

CS_SMS, which is a leaf that enables or disables UE-originated SMS via CS links;

PS_SMS, which is a leaf that enables or disables UE-originated SMS via PS links;

CS_LCS, which is a leaf that enables or disables UE-originated LCS operations via CS links;

PS_LCS, which is a leaf that enables or disables UE-originated LCS operations via PS links;

GPRS_SM_PDP, which is a leaf that enables or disables UE-originated GPRS Session Management (SM) procedures for packet data protocol (PDP) contexts, e.g., PDP context activation, deactivation, and modification;

GPRS_SM_MBMS, which is a leaf that enables or disables GPRS SM procedures for MBMS contexts, e.g., MBMS context activation and deactivation;

IMS, which is a leaf that enables or disables IMS procedures for sending IMS registration requests;

Text, which is a leaf that includes information that can be displayed by the UE to the user;

CustomerCareNumbers, which is an interior node that enables or disables a reference to a list of customer care service numbers;

CustomerCareNumbers/<X>/CustomerCareNumber, which is a leaf that represents a customer care service number that can be used by the user in determining the cause of non-availability of specific services;

AlertServerID, which is a leaf that indicates a DM Server identifier and enables informing the DM Server about an SDOUE MO that has been modified;

IMS_EmergencyCalls, which is an interior node that indicates a network operator's preference to enable or disable emergency call procedures over IMS, which are specified in 3GPP TS 24.229, for example;

IMS_EmergencyCalls/<X>/Country, which is a leaf that represents a country, which may be identified by an MCC, and enables, with the Network leaf, inclusion of information that indicates in which MCC and MNC the emergency call procedures over IMS are disabled;

IMS_EmergencyCalls/<X>/Country/Network, which is a leaf that represents a network, which may be identified by an MNC, and enables, with the Country leaf, inclusion of information that indicates in which MCC and MNC the emergency call procedures over IMS are disabled; and

Ext, which is an interior node that can be used for information about the SDOUE MO, e.g., application vendor, UE vendor, etc.

A leaf typically takes on either of two values, e.g., either 0 or 1, and it will be appreciated that the particular value taken is not critical, only the effect of a particular value need be predetermined.

For example, when the CS_Calls leaf value is set to 1, the UE initiates the release of all active calls except for emergency calls, and enters a “null” state such as that described in 3GPP TS 24.008. The UE does not use UE-originated CC procedures except for emergency calls and customer care service number(s), if indicated by the Text leaf, until the CS_Calls leaf value is set to 0.

When the CS_EmergencyCalls leaf value is set to 1 and the UE detects a predetermined public land mobile network (PLMN), which can be identified by an MCC and MNC, then the UE initiates a signaling procedure for release of all emergency calls. Furthermore, the UE may not use CC procedures to establish emergency calls until the CS_EmergencyCalls leaf value is set to 0 or the UE detects an MCC and MNC that does not match any of its stored pairs of codes.

When the SupplementaryServices leaf value is set to 1, the UE terminates all active SS operations, and does not invoke SS operations and their responses until the SupplementaryServices leaf value is set to 0.

When the CS_SMS leaf is set to 1, the UE does not use the CS domain for UE-originated SMS transfer until the CS_SMS leaf value is set to 0. Similarly, when the PS_SMS leaf is sent to 1, the UE does not use the PS domain for UE-originated SMS transfer until the PS_SMS leaf value is set to 0.

When the CS_LCS leaf value is set to 1, the UE does not use the CS domain for UE-originated LCS service operations until the CS_LCS leaf value is set to “0”. Similarly, when the PS_LCS leaf value is set to 1, the UE does not use the PS domain for UE-originated LCS service operations until the PS_LCS leaf value is set to 0.

When the GPRS_SM_PDP leaf value is set to 1, the UE releases all resources allocated for active PDP contexts, and the UE may erase the PDP context data and enter a standby or idle state. The UE does not use UE-originated GPRS SM procedures until the GPRS_SM_PDP leaf value is set to 0, although the UE can advantageously be allowed to use the UE-originated GPRS SM procedures for PDP context activation in particular cases. For example, UE-originated GPRS SM procedures for PDP context activation can be used upon receiving an OMA DM notification message indicating that the UE should initiate an OMA DM session to the DM server that had set the disable value of the GPRS_SM_PDP leaf. For another example, UE-originated GPRS SM procedures for PDP context activation can be used when they are necessary either to establish an emergency call over IMS (e.g., if the IMS_EmergencyCalls value is set to 0) or to send an OMA DM generic alert message.

When the GPRS_SM_MBMS leaf value is set to 1, the UE releases resources allocated for active MBMS contexts, and may erase the MBMS context data. The UE does not use GPRS SM procedures for MBMS contexts until the GPRS_SM_MBMS leaf value is set to 0.

When the IMS leaf value is set to 1, the UE initiates the user-initiated deregistration procedure for IMS, and does not send an IMS registration request until the IMS leaf value is set to 0. It will be noted that disabling GPRS_SM_PDP Contexts is a second step to disable a misbehaving IMS application's repeatedly sending IMS registrations.

The information contained in the Text leaf should be in the UE's selected language and may assist in determining the cause of non-availability of specific services and what to do. For example, the Text leaf may include a text string indicating the disabled service(s) and one or more telephone numbers, Internet addresses, etc. for customer service.

The AlertServerID leaf value can be used by the UE to send a DM generic alert message any time the SDOUE MO is modified by an OMA DM server that is different from the server indicated by the AlertServerID leaf value. Table 2 is an exemplary definition of a suitable DM generic alert message.

TABLE 2
Exemplary DM generic alert message

```
<Alert>
  <CmdID>2</CmdID>
  <Data>1226</Data>  <!-- Generic Alert -->
  <Item>
    <Source><LocURI>./SDoUE </LocURI></Source>
    <Meta>
      <Type xmlns=“syncml:metinf”>
        Reversed-Domain-Name:
        org.3gpp.SDoUE.changesperformedalert
      </Type>
      <Format xmlns=“syncml:metinf”>char</Format>
    </Meta>
    <Data>
      CS_SMS disabled; Vodafone UK <!-The modified
node/leaf and status; OMA DM server ID which made the change -->
    </Data>
  </Item>
</Alert>
```

It will be noted that the Type element of a DM generic alert message such as that illustrated by Table 2 can advantageously be set to “Reserved-Domain-Name: org.3gpp.SDoUE.changesperformedalert”. It will also be appreciated, however, that the particular names and structure shown are not essential as techniques described in this application can be implemented with other names and tree structures.

When the IMS_EmergencyCalls leaf value is set to 1 and the UE detects coverage by a PLMN (identified by MCC and MNC) as indicated by any of the stored Country and Network pairs of nodes, then the UE initiates a signaling procedure to release all emergency calls over IMS. Furthermore, the UE does not use IMS procedures to establish emergency calls until the IMS_EmergencyCalls leaf value is set to 0 or the UE detects an MCC and MNC that do not match any of the stored Country and Network pairs of nodes.

An example of a device description framework (DDF) that implements the above-described logical structure of an SDOUE MO is provided below as Table 3. The artisan will understand that features can be re-arranged, added to, omitted from, and renamed in the DDF without departing from this invention.

The SDOUE MO advantageously is able to disable and enable services while the UE is on either its home PLMN (HPLMN), which is the PLMN that maintains the UE's subscription, or on a visited PLMN (VPLMN). It is also desirable for both the HPLMN and the VPLMN to provide an indication to the UE as to which functions the UE is or is not allowed to use. Two alternative methods of operating the UE and network are described below.

In the first method, the SDOUE MO is fully controlled by the user's home operator (HPLMN) and only the HPLMN can disable/enable services in the UE. This first method is depicted in the flow chart of FIG. 2 and includes the following steps.

The VPLMN, or the HPLMN for that matter, notices (step 202) that one or more UEs acts repeatedly to request services/connections to the network and (exceptionally) fails to be detected and disabled by application-layer preventative measures, i.e., the HPLMN or VPLMN notices a misbehaving UE.

Depending on the architecture of the HPLMN and VPLMN and on the services provided, different network nodes are involved in noticing a misbehaving UE. For example, for service based in the CS domain, a mobile switching center (MSC), visiting location register (VLR), and home subscriber server (HSS) would usually be involved. For PS-based services, a serving GPRS support node (SGSN) is usually involved. For IMS, a serving call/session control function (S-CSCF) can be involved. Thus, these network nodes, or more particularly processors in such nodes, include programming suitable for detecting UE misbehavior. From a functional point of view, detected misbehavior can be reported to a policy control node, which may be collocated with or integrated in a DM Server, for appropriate action. A network having such entities is described in more detail below.

If the misbehavior is noticed by a VPLMN, the VPLMN informs the HPLMN, e.g., a customer care center of the HPLMN, of the misbehaving UE (step 204). This communication may be carried in various ways, e.g., via internet service interfaces that connect customer care centers of the HPLMN and VPLMN.

The HPLMN's customer care center requests the HPLMN's DM Server 104 to disable the service that is misused by the misbehaving UE (step 206). The HPLMN's DM Server 104 sends a suitable message, such as a notification-initiated-session message, to the misbehaving UE to establish a DM management session towards the misbehaving UE (step 208). Notification-initiated-session messages are described in, for example, OMA TS-DM-Protocol-V1_{—}2-20060424-C. In the established management session, the HPLMN's DM Server accesses the SDOUE MO (step 210), disabling the misused service by setting the appropriate parameter value in the SDOUE MO.

When a service or function is disabled by a PLMN, a text string is usually displayed to the UE's user that contains ways to contact an appropriate customer care center in order to get information about, for example, the service/function disabled, assistance with determining the cause of non-availability of the service/function, and re-enablement of the service/function.

In the second method of operating a UE and network, the SDOUE MO is controlled by the HPLMN, but a VPLMN can also disable/enable services and thus access and modify the SDOUE MO. In this second method, information needed to access the SDOUE MO is made available to the VPLMN for accessing and disabling/enabling services to a UE roaming on the VPLMN. The needed information for the VPLMN to access the UE and the SDOUE MO is preferably configured in the UE by the HPLMN.

The information that the HPLMN needs to provide in the UE for the VPLMN is a DM Account MO, which is preferably one of the OMA DM Standardized Objects described in OMA-TS-DM-StdObj-V1_{—}2-20060424-C, and the necessary connectivity (e.g., a needed Connectivity MO) for the UE to connect to the VPLMN, which also is preferably one of the OMA DM Standardized Objects. It will be understood that “connectivity” here is the connectivity information that the UE needs in order to set up an IP connectivity towards the HPLMN's DM Server, e.g., the name “telia-online.se” as Access Point Name (APN) when connecting via GPRS to Telia's network.

The provision of the needed information can happen at any time, e.g., at manufacture of the UE, the first time the UE is switched on, and when the UE roams onto the VPLMN. The HPLMN's OMA DM Server configures the UE's access rights so that part of the SDOUE MO is manageable by the VPLMN. The HPLMN may, for example, use the OMA DM ACL mechanism to define which VPLMN can access the SDOUE MO. The needed information can be downloaded on the UE through an established DM management session.

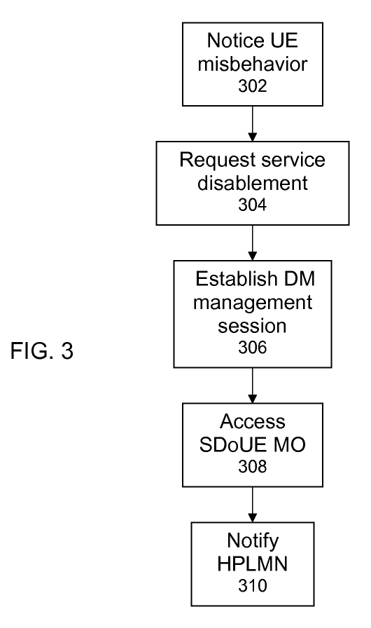

The second method of operating a UE and a communication system is depicted in the flow chart of FIG. 3. In step 302, the VPLMN notices a misbehaving UE, just as in the first method depicted in FIG. 2. In step 304, the VPLMN's customer care center requests the VPLMN's DM Server 104 to disable the service that is misused by the misbehaving UE. The VPLMN's DM Server sends a suitable message, such as an OMA notification-initiated-session message, to the misbehaving UE to establish an DM management session towards the misbehaving UE (step 306). If the UE accepts the request for access to modify the SDOUE MO, the VPLMN is able to enable/disable functions specified by the SDOUE parameters. The established management session allows the VPLMN's DM Server 104 to access the SDOUE MO to disable the misused service (step 308).

The HPLMN may wish to be informed of any change performed to the UE's SDOUE MO. In that case, the method further includes notifying the HPLMN when a VPLMN has made changes to the SDOUE MO (step 310). For example, the misbehaving UE can notify the HPLMN that changes to its SDOUE MO have been made by sending a DM generic alert message to the HPLMN's DM Server. The DM Server receives the notification, and as usual the DM Authority decides what to do when such a notification arrives. It will be understood that the VPLMN, instead of or even in addition to the UE, can notify the HPLMN of changes made to the UE's SDOUE MO, but at this time no protocol is specified for this purpose.

To implement the method depicted in FIG. 3, the structure of the SDOUE MO depicted in Table 1 should be modified by adding a parameter that contains the identifier of the HPLMN's DM Server 104, to which the DM generic alert message is sent when the UE's SDOUE MO is changed.

It will be understood that the first and second methods include features that support security aspects of the SDOUE MO, e.g., resistance to man-in-the-middle attack. Currently, OMA DM uses wireless transport layer security/secure sockets layer version 3 (WTLS/SSL3) with a minimum of 128-bit encryption and allows implementation with more secure encryption and cipher suites.

The bearer between the UE and the DM Server is normally over IP and the GPRS (or PS Domain) bearer. Thus, in the case when the GPRS service and PDP context activation are disabled, the problem of activation of a PDP context for UE-DM Server communication has to be resolved. In accordance with this invention, the problem is resolved by conceptually viewing the activation as a network-initiated bearer request. The inventors have recognized that UE-terminated SMS never needs to be disabled and thus OMA DM can use the wireless application protocol (WAP) Push mechanism to establish the GPRS bearer needed for UE-DM Server communication. The WAP Push application is allowed to trigger PDP context activations selectively, in particular to a DM Server, while other applications in the UE are blocked from requesting PDP Context activation by the disabling of the GPRS service and PDP context activation.

It will be appreciated that a UE may, for example, use a Connectivity MO for application-independent settings to connect to a WAP network that would provide connectivity information that relates to the parameters and means needed to access the WAP infrastructure, including network bearers, protocols, Network Access Point (NAP) addresses, and proxy addresses. A WAP proxy is an endpoint for the wireless transport protocol (WTP), the wireless session protocol (WSP), and the WTLS protocol, as well as a proxy that is able to access WAP content. A WAP proxy can have functionality such as that of, for example, a WSP proxy or a wireless telephony application (WTA) proxy. A physical proxy is a specific address with proxy functionality, e.g., an IP address plus port for an IP-accessible proxy, and a short message entity (SME)-address plus port for a proxy accessible via the SMS. A logical proxy is a set of physical proxies that may share the same WSP and WTLS context (shared session identification value space).

According to OMA specifications, a Connectivity MO enabler handles management of wireless data connectivity by specifying a set of DM object schema that may be exposed by a DM Client and targeted by a DM Server. The object schema have three parts: a top level management object that is bearer-neutral; a set of bearer-specific parameters; and a sub-tree for exposing vendor-specific parameters. Connectivity parameters bootstrapped using Client Provisioning (CP) can be subsequently addressed and managed through the DM Server, which can add new proxies and NAPs using a standardized DM package. Provisioning is the process by which a client, such as a WAP client in a device, is configured, and generally covers both over the air (OTA) provisioning and other provisioning, e.g., by a SIM card.

It will be appreciated that OMA DM needs the UE to set up a UE-originated GPRS SM procedure (e.g. a PDP context) to allow the OMA DM Server to contact and configure the SDOUE MO in order to enable/disable services. As described in this application, the UE is allowed to set up a UE-originated GPRS SM procedure for that case. In addition, when UE-originated GPRS SM procedures for PDP contexts are disabled, the UE has to initiate the signaling procedure for PDP context deactivation of all PDP contexts according to 3GPP TS 24.008 and the UE is not allowed to use UE-originated GPRS SM procedures for PDP contexts until the UE-originated GPRS SM procedures for PDP contexts are enabled. The UE is however allowed to use UE-originated GPRS SM procedures for PDP context activation in the following cases:

upon receipt of an OMA DM notification message indicating that the UE shall initiate an OMA DM session to the OMA DM Server that had set the disable value of the GPRS_SM_PDP leaf; and

when the UE-originated PDP context activation procedure is necessary in order to either establish an emergency call over IMS (if the IMS_EmergencyCalls value is set to 0) or send an OMA DM generic alert message.

Another example is the case of CS and IMS emergency calls. In order not to disable emergency call procedures in regions where support is required, the network operator may indicate in which country and/or network(s) the emergency call control procedures are disabled. Emergency call procedures can then be disabled until otherwise indicated or until the UE determines that it has entered a country or network that is not indicated as disabled. If emergency call control procedures are disabled and the UE again regains coverage in a country or network indicated as disabled, the non-availability of the emergency call service will again take effect. The Country and Network nodes in the SDOUE MO, if present, can be considered a pair of nodes, where MCC+MNC=network operator, but it is possible to indicate a country/region by setting only the value of the Country node (e.g., setting MCC to the numeric value that indicates Sweden). Thus, emergency call disable will be effective in the whole country, Sweden.

The behavior of the logic in the UE advantageously follows rules such as the following when UE-originated PDP context activations have been disabled but the UE is allowed to make a PDP Context activation for DM usage:

1. the feature is activated in a UE that has been bootstrapped with and configured by a DM Server;

2. the UE's DM Client requests PDP context activation only when it has received an OMA DM notification through the WAP Push mechanism; and

3. the DM notification carries the DM Server ID and a suitable security integrity indicator or token, such as an MD5 hash.

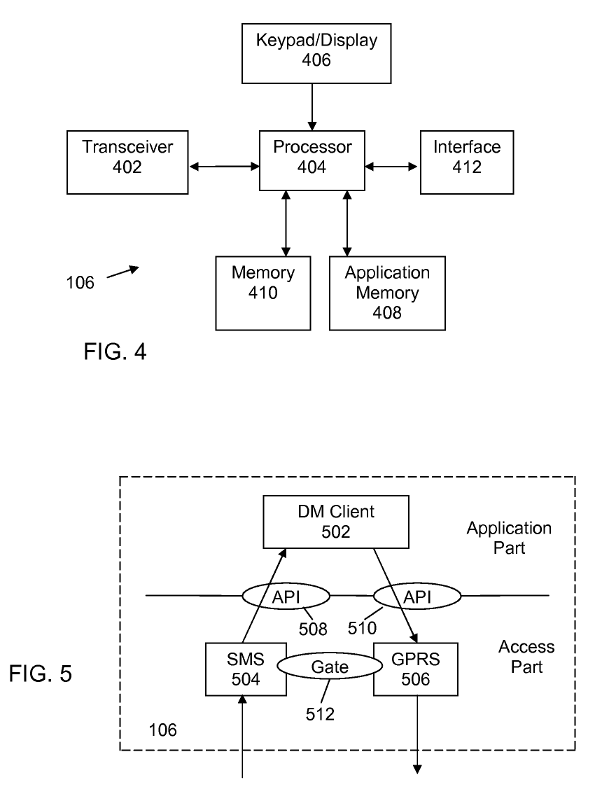

FIG. 4 is a block diagram of a typical UE 106, including a transceiver 402 that is suitable for exchanging radio signals with base stations (BSs) in a network (not shown in FIG. 4). Information carried by those signals is handled by a processor 404, which may include one or more sub-processors, and which executes one or more software modules and applications, including the SDOUE MO described in this application, to carry out the operations of the UE 106 according to the MOs described above. User input to the terminal is provided through a keypad or other device, and information presented to the user is provided to a display 406. Software applications may be stored in a suitable application memory 408, and the device may also download and/or cache desired information in a suitable memory 410. The device 106 also includes an interface 412 that can be used to connect other components, such as a computer, keyboard, etc., to the UE 106.

To protect against improperly triggered PDP context activations by a misbehaving application, the implementation of the selective disabling feature in the UE 106 can employ an internal gate control, which is illustrated by FIG. 5. In FIG. 5, the software in a UE 106 is depicted as separated into an application part, supporting a DM Client 502, and an access part, supporting an SMS functionality 504 and a GPRS functionality 506. The software in the application and access parts can communicate through APIs 508, 510. A gate control 512, which advantageously is implemented by suitable programming or logic in both the SMS 504 and GPRS 506, operates in such a way that a PDP context activation request arriving at an API 508, 510 is sent only when a proper WAP Push notification has previously been received towards the DM Client 502. The gate 512 can use the Application ID in the WAP Push notification message as a token. The gate 512 opens by making a token available, and a request for a PDP context from the DM Client 502 is accepted only if a token is available at the GPRS 506 when the request is received over the API 510. In addition to generating a token, the gate functionality may include a timer that limits the duration of the validity of the token.

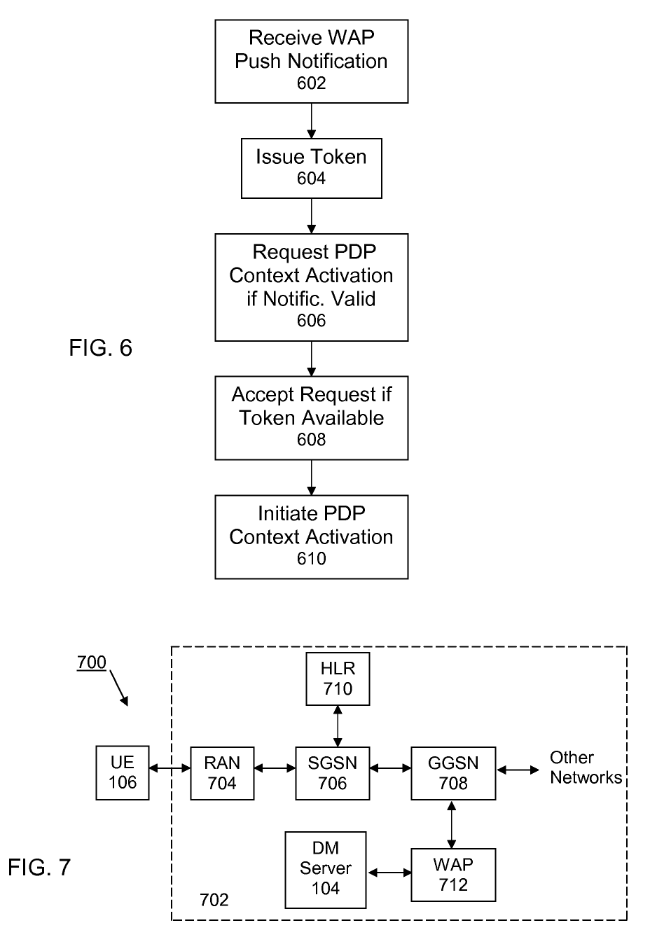

FIG. 6 is a flow chart of an exemplary method of controlling PDP context activation using the gate 512 that can be included in the methods depicted in FIGS. 2 and 3. In step 602, a WAP Push notification carried in an SMS message is received by the SMS 504 from a DM Server 104. As noted above, the WAP Push notification includes a suitable Application ID, and in response to the notification (step 604), the gate functionality in the SMS 504 issues a token, and optionally a timer is started. The DM Client 502 receives the WAP Push notification, and if it is from an authorized DM Server, i.e., it has the proper ID, the DM Client 502 requests a PDP context from the GPRS functionality 506 (step 606). GPRS 506 accepts the DM Client's request if a token is available (step 608), and initiates a PDP context activation procedure (step 610). It will be appreciated that the functionality of the gate 512 may be implemented in many ways, for example by software included in the SMS 504 and/or the GPRS 506.

Besides using the SDOUE MO to protect their network capacity against improper behavior by UEs, network operators may find other uses for it. For example, when an end-user has not paid for a service requested or has subscribed to a service and later stopped paying for the service, an operator can use the SDOUE MO to disable the UE software or functionality associated with the service.

It will be understood that in an OMA DM environment, decision making is usually not done at the level of the DM Server; the MA makes decisions and then DM Servers carry out the operations. A UE can also have several MAs and respective DM Servers. For example, a mobile phone may be managed by a MA of a wireless network operator via several of the operator's OMA DM Servers, and by a MA of the phone user's employer via other OMA DM Servers. The operator can be responsible for managing connectivity for the operator's network, including keeping a roaming list of the cheapest roaming settings that is valid for the user's subscription to the operator. The employer can be responsible for tracking and management of all corporate applications on the device. The phone's user may also decide, completely unknown to any of the OMA DM Servers, to download and install other software on the device.

FIG. 7 is a block diagram of a communication system 700 that includes a portion of a typical network 702 and a UE 106 that is capable of having its services selectively disabled and enabled with an SDOUE MO as described in this application. It will be understood that many arrangements of network entities other than that depicted in FIG. 7 can be used, that a UE may also connect to a network such as the internet via wireless local area networking (WLAN) such as IEEE 802.11, WiMAX (IEEE 802.16), etc., and that the UE may use a 3GPP interworking WLAN.

In FIG. 7, the UE 106 communicates with the network 702, which typically includes a radio access network (RAN) 704, such as a 3GPP or GSM/EDGE network, and core-network entities, including an SGSN 706, a gateway GPRS support node (GGSN) 708, and a home location register (HLR) 710. The GGSN 708 communicates with other networks, such as the internet and a VPLMN, and other entities, such as a WAP infrastructure 712 and a DM Server 104.

The RAN 704 typically includes one or more BSs and base station controllers, or Node Bs and radio network controllers (RNCs), that are conventional. The RNCs control various radio network functions, including for example radio access bearer setup, diversity handover among BSs, etc. More generally, each RNC directs calls to and from a UE via the appropriate BSs, which communicate with each other through downlink (i.e., base-to-mobile or forward) and uplink (i.e., mobile-to-base or reverse) channels. Each BS serves a geographical area that is divided into one or more cell(s) and is typically coupled to its corresponding RNC by dedicated telephone lines, optical fiber links, microwave links, etc.

The core-network entities (SGSN, GGSN, etc.) are adapted to handle many types of data. In a typical GSM/EDGE network, PDP contexts for administering data flows are set up, or activated, in the GGSN 608 in response to requests from the UE 106. It will be understood that a UE can also connect to the network via WLAN access.

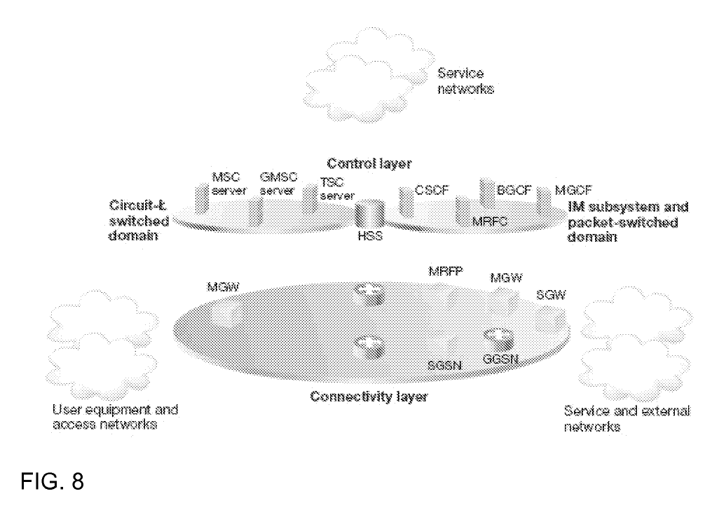

For easier understanding, the network 702 may be organized based on functionality into a control layer or plane, a connectivity layer or plane, and an application layer or plane, as depicted in FIG. 8. In this depiction, UEs and radio access networks are depicted by “clouds”, and other network entities are depicted by other clouds. Such an organization is described in more detail in, e.g., H. Hameleers et al., “IP Technology in WCDMA/GSM Core Networks”, Ericsson Review No. 1, pp. 14-27 (2002). The control layer hosts network control servers, such as DM Servers 104, that include programmed processors, that are in charge of call or session set-up, modification, and release. The control servers might also handle mobility management, security, charging, and interworking functions that relate to external networks at the control plane level. The connectivity layer hosts routers, switches, signaling gateways, media gateways (MGWs), and other user-plane functions. The routers and switches provide transport capabilities for traffic on the control and user planes. The MGWs facilitate interworking on the user plane, including interworking between different radio access technologies and media formats.

The interface between the control layer and the connectivity layer mainly consists of gateway control protocols. The network control servers use these interfaces to manipulate MGW resources in the connectivity layer. The application layer, which is implemented as part of the service network, hosts application and content servers.

There are two interfaces between the core network and the service network: a horizontal interface and a vertical interface. The horizontal interface between the core network and the service network refers to regular peer-to-peer or client/server mode of operation for typical end-user applications, such as Web browsing, e-mail and audio/video services. These applications are normally invoked by an end-user but might also be invoked by an application server. The vertical interface allows applications that reside on specific application servers to complement or modify the normal procedures for setting up calls or sessions through the core network. These applications interwork with the core network through a set of standardized APIs.

In the CS domain, a mobile services center (MSC), gateway MSC (GMSC) and transit services switching center (TSC) servers are part of the control layer. A corresponding MGW belongs to the connectivity layer. In the PS domain, both the SGSN and the GGSN can be considered to be part of the connectivity layer—they contain some control functionality—but their dominant functionality lies in providing IP connectivity. With 3GPP, a “domain” added to the mobile core network is the IMS, which has as principal network entities a call/session control function (CSCF); a media gateway control function (MGCF); a breakout gateway control function (BGCF); a media resource function (MRF) control part, or MRFC; a MRF processing part (MRFP); a media gateway (MG); and a signaling gateway (SG). A master subscriber database, called the home subscriber server (HSS), is common to CS domain, the PS domain, and the IMS.

It will be appreciated that a UE can implement the techniques described in this application without using the above-described tree structure and DDF, which are merely specific examples that have specific node names, etc. The exemplary DDF is in a machine-readable format, which can be read by suitable tools that create the tree structure with little additional help. Implementations that use different names will use different DDFs.

The invention described here can be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a RAM, a ROM, and an erasable programmable read-only memory (EPROM or Flash memory).

It is expected that this invention can be implemented in a wide variety of environments, including for example mobile communication devices. It will also be appreciated that procedures described above are carried out repetitively as necessary. To facilitate understanding, aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

Thus, the invention may be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action. It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

What is claimed is:

1. A method of operating a user equipment (UE) in a public land mobile network (PLMN), comprising the steps of:
determining that the UE improperly requests at least one service from the PLMN;
informing a management entity in a home public land mobile network (HPLMN) of the improper request;
requesting, by the HPLMN's management entity, a device management computer server in the HPLMN to disable the improperly requested service in the UE;
sending, from the HPLMN's server, a message to the UE to establish a management session between the UE and the server; and
accessing a selective disabling of UE capabilities (SDOUE) management object in the UE such that the improperly requested service is disabled.

2. The method of claim 1, wherein at least one of call control procedures, circuit-switched emergency calls, emergency call over an internet protocol multimedia system, and UE-originated general packet radio service (GPRS) session management (SM) procedures is disabled.

3. The method of claim 2, further comprising the step of, when UE-originated GPRS SM procedures are disabled, initiating deactivation of packet data protocol (PDP) contexts.

4. The method of claim 3, further comprising the steps of:
receiving a short message service (SMS) message that includes a wireless application protocol (WAP) Push notification;
issuing a token based on the WAP Push notification;
requesting a PDP context; and
initiating a PDP context activation if the token is issued.

5. The method of claim 4, further comprising initiating a management session using the activated PDP context to a server that caused disabling of the GPRS SM procedures.

6. The method of claim 4, further comprising at least one of the following steps using the activated PDP context:
establishing an emergency call over an internet-protocol multimedia subsystem service and sending an alert message.

7. The method of claim 4, further comprising the step of activating a timer based on the WAP Push notification, wherein the PDP context activation is initiated if the timer has not timed out.

8. The method of claim 4, wherein the WAP Push notification includes an application identification.

9. A user equipment (UE) capable of communication with a device management server, comprising:
a processor configured to execute software components existent in the UE and control UE services;
wherein the software components include a selective disabling of UE capabilities (SDOUE) management object that is configurable by the processor to disable UE services based on a management session established between the UE and the server.

10. The UE of claim 9, wherein at least one of call control procedures, circuit-switched emergency calls, emergency call over an internet protocol multimedia system, and UE-originated general packet radio service (GPRS) session management (SM) procedures is disabled.

11. The UE of claim 10, wherein when UE-originated GPRS SM procedures are disabled, the processor initiates deactivation of packet data protocol (PDP) contexts.

12. The UE of claim 11, wherein the software components include a device management client in an application part of the software components and a short message service (SMS) and a GPRS in an access part of the software components; the SMS issues a token based on an SMS) message received by the UE that includes a wireless application protocol (WAP) Push notification; the device management client requests a PDP context; and the GPRS initiates a PDP context activation if the token is issued.

13. The UE of claim 12, wherein the processor is configured to initiate a management session using the activated PDP context to a server that caused disabling of the GPRS SM procedures.

14. The UE of claim 12, wherein the processor is configured to establish an emergency call over an internet-protocol multimedia subsystem service or send an alert message using the activated PDP context.

15. The UE of claim 12, further comprising a timer that is actuatable based on the WAP Push notification, wherein the PDP context activation is initiated if the timer has not timed out.

16. A computer-readable medium having instructions that, when executed by a processor in a user equipment (UE) in a public land mobile network (PLMN), cause the processor to perform the steps of:
determining that the UE improperly requests at least one service from the PLMN;
informing a management entity in a home public land mobile network (HPLMN) of the improper request;
requesting, by the HPLMN's management entity, a device management computer server in the HPLMN to disable the improperly requested service in the UE;
sending, from the HPLMN's server, a message to the UE to establish a management session between the UE and the server; and
accessing a selective disabling of UE capabilities (SDOUE) management object in the UE such that the improperly requested service is disabled.

17. The medium of claim 16, wherein at least one of call control procedures, circuit-switched emergency calls, emergency call over an internet protocol multimedia system, and UE-originated general packet radio service (GPRS) session management (SM) procedures is disabled.

18. The medium of claim 17, wherein the processor further performs the step of, when UE-originated GPRS SM procedures are disabled, initiating deactivation of packet data protocol (PDP) contexts.

19. The medium of claim 18, wherein the processor further performs the steps of:
receiving a short message service (SMS) message that includes a wireless application protocol (WAP) Push notification;
issuing a token based on the WAP Push notification;
requesting a PDP context; and
initiating a PDP context activation if the token is issued.

20. The medium of claim 19, wherein the processor further performs the step of initiating a management session using the activated PDP context to a server that caused disabling of the GPRS SM procedures.

21. The medium of claim 19, wherein the processor further performs at least one of the following steps using the activated PDP context:
establishing an emergency call over an internet-protocol multimedia subsystem service and sending an alert message.

22. The medium of claim 19, wherein the processor further performs the step of activating a timer based on the WAP Push notification, wherein the PDP context activation is initiated if the timer has not timed out.

23. The medium of claim 19, wherein the WAP Push notification includes an application identification.
